(19) United States
(12) Patent Application Publication
(10) Pub. No.: US 2026/0330747 A1
(43) Pub. Date: Oct. 22, 2026

(54) THREE-DIMENSIONAL SCENE RECONSTRUCTION FROM A SINGLE IMAGE USING DIFFUSION-BASED GAUSSIAN SPLAT GENERATION

(71) Applicant: Niantic Spatial, Inc., San Francisco, CA (US)

(72) Inventors: Ziwei Liao, Beijing (CN); Mohamed Amr Abdelfattah Sayed, London (GB); Sara Alexandra Gomes Vicente, London (GB); Daniyar Turmukhambetov, London (GB); Michael David Firman, Bristol (GB)

(21) Appl. No.: 19/649,684

(22) Filed: Apr. 16, 2026

Related U.S. Application Data
(60) Provisional application No. 63/789,808, filed on Apr. 16, 2025.

(51) Int. Cl. G06T 15/20; G06N 3/0455; G06N 3/0895; G06T 15/08; G06T 17/20

(52) U.S. Cl. CPC G06T 15/20; G06N 3/0455; G06N 3/0895; G06T 15/08; G06T 17/20

(57) ABSTRACT

A method for generating a three-dimensional scene representation from a single input image. The method encodes the input image using a first encoder to generate conditioning features, concatenates the conditioning features with a random latent code, and iteratively denoises the combined representation using a denoising diffusion model to produce a denoised latent code. A decoder transforms the denoised latent code into a splatter image representation comprising a pixel-aligned grid of Gaussian splat parameters representing both observed and unobserved surfaces of the scene. The splatter image representation is backprojected into three-dimensional space to produce a set of three-dimensional Gaussian splats for rendering the scene from arbitrary viewpoints. Skip connection features derived from a second encoder may be provided to the decoder to preserve high-frequency detail. Multiple diverse scene completions may be generated by repeating the process with different random latent codes.

### CROSS REFERENCE TO RELATED APPLICATIONS

This application claims the benefit of U.S. Provisional Patent Application No. 63/789,808, filed Apr. 16, 2026, which is incorporated by reference.

### BACKGROUND

### 1. Technical Field

The subject matter described herein relates to three-dimensional scene reconstruction from a single image, and more particularly to generating pixel-aligned Gaussian splat representations of observed and unobserved surfaces using denoising diffusion models.

### 2. Problem

Three-dimensional scene reconstruction from images is a fundamental challenge in computer vision with applications in augmented reality (AR), virtual reality (VR), and spatial computing. Conventional approaches to 3D reconstruction typically require multiple images captured from different viewpoints to reconstruct a scene, which increases data acquisition complexity and computational cost. When a single image is available, reconstructing a complete 3D representation is particularly difficult because many portions of the scene are occluded or fall outside the camera's field of view. Existing single-image reconstruction techniques have attempted to address this challenge, but they suffer from significant limitations. Some approaches focus exclusively on isolated foreground objects and fail to reconstruct background surfaces, limiting their applicability to real-world scenes that include both foreground and background elements. Other approaches reconstruct only the surfaces directly visible in the input image, leaving gaps and artifacts when the scene is viewed from novel viewpoints. Regression-based methods that attempt to predict unobserved surfaces tend to produce blurry and implausible results because they are constrained to output a single deterministic prediction, effectively averaging together all possible explanations for the hidden portions of the scene into one blurred estimate. This unimodal prediction behavior fails to capture the inherent ambiguity of unobserved surfaces, where multiple plausible completions may exist for a given input image. These deficiencies limit the quality and completeness of 3D scene representations generated from single images, particularly for applications that require realistic rendering from arbitrary viewpoints.

### SUMMARY

Techniques described herein provide systems and methods for generating a three-dimensional scene representation from a single input image by combining a pixel-aligned Gaussian splat representation with a denoising diffusion model operating in a learned latent space. The method encodes the input image using a first encoder to produce conditioning features, concatenates those features with a random latent code, and iteratively denoises the combined representation using a denoising diffusion model to produce a denoised latent code. A decoder then transforms the denoised latent code into a splatter image representation, which is a pixel-aligned grid of Gaussian splat parameters representing both the observed and unobserved surfaces of the scene. The splatter image representation is backprojected into three-dimensional space to produce a set of Gaussian splats that may be rendered from arbitrary viewpoints in real time. Skip connection features derived from a second encoder may be provided to the decoder to preserve high-frequency detail from the input image, improving the fidelity of visible surfaces in the reconstructed scene.

This approach provides several technical improvements over conventional single-image reconstruction techniques. By performing denoising in a compact latent space rather than directly in pixel space, the method reduces computational overhead while maintaining reconstruction quality. The diffusion-based architecture enables the system to generate sharp, coherent completions of unobserved surfaces rather than the blurry averaged predictions produced by regression-based methods, because each denoising pass may commit to a single plausible mode of the output distribution. The systems and methods may also generate multiple diverse scene completions from a single input image by initiating the denoising process from different random latent codes, providing a range of plausible reconstructions for ambiguous or heavily occluded regions. The balance between fidelity to the input image and diversity of completions may be controlled at inference time through adjustable parameters, including a classifier-free guidance weight and a skip connection weight, without requiring retraining of the model.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for generating three-dimensional scene representations from a single image using Gaussian splats combined with denoising diffusion models, according to one embodiment.

FIG. 4 illustrates a training pipeline for learning a latent space of splatter image representations using an encoder-decoder network with self-supervised losses, according to one embodiment.

FIG. 5 illustrates a training pipeline for training a denoising diffusion model on latent codes produced by the encoder-decoder network of FIG. 4, according to one embodiment.

FIG. 6 illustrates an inference pipeline for generating a splatter image representation from a single input image using the trained denoising diffusion model, according to one embodiment.

FIG. 7 illustrates the generation of multiple diverse three-dimensional scene representations from a single input image, according to one embodiment.

FIG. 8 is a flowchart of a method for generating a three-dimensional scene representation from a single input image using Gaussian splats combined with denoising diffusion models, according to one embodiment.

FIG. 9 illustrates an example computer system suitable for use in the networked computing environment of FIG. 3, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes AR content in a virtual world geography that parallels at least a portion of the real-world geography such that player movement and actions in the real world affect actions in the virtual world. The subject matter described is applicable in other situations where generating three-dimensional scene representations from a single image using Gaussian splats combined with denoising diffusion models is desirable, such as robotics and self-driving vehicles. In addition, the inherent flexibility of computer-based systems allows for a great variety of possible configurations, combinations, and divisions of tasks and functionality between and among the components of the system.

### Example Location-Based Parallel Reality Game

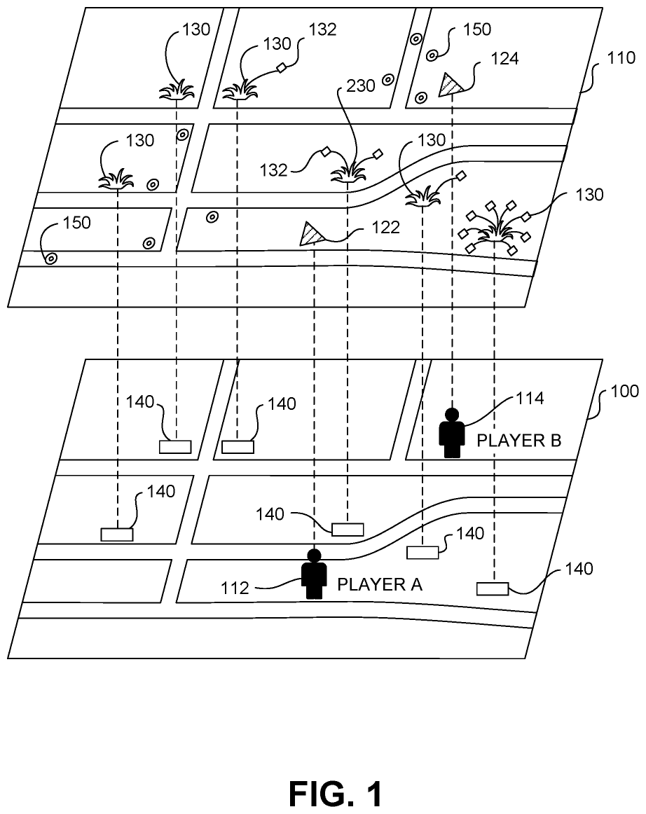

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

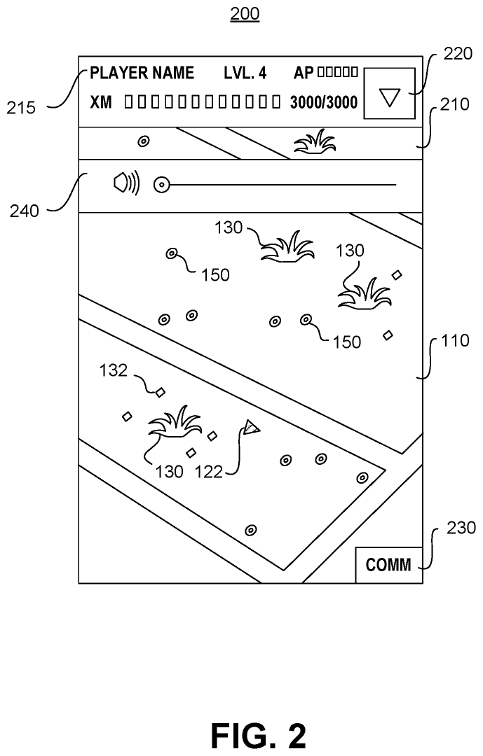

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Location-Aware Application System

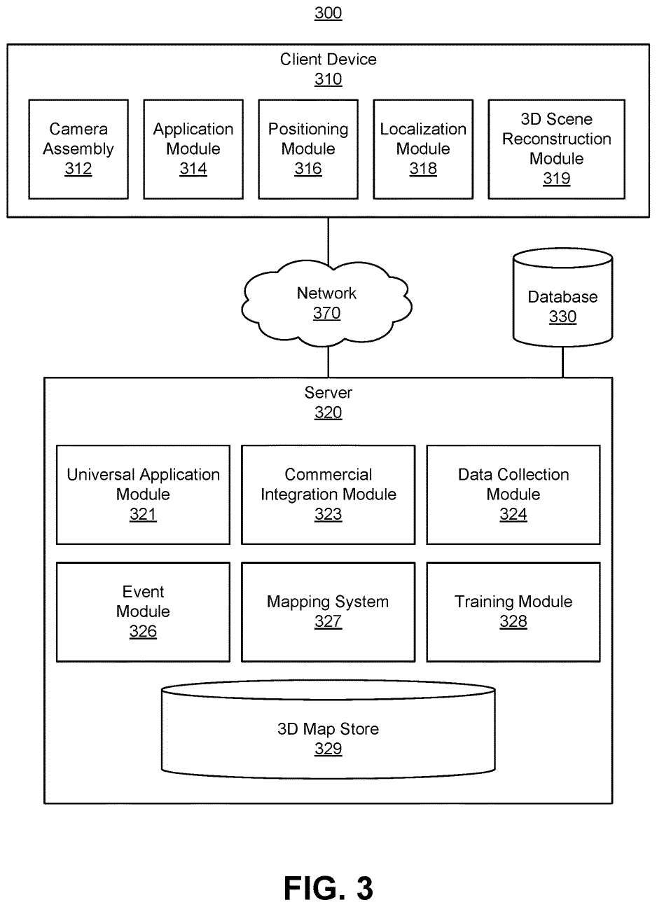

FIG. 3 illustrates one embodiment of a networked computing environment 300. The networked computing environment 300 uses a client-server architecture, where a server 320 communicates with a client device 310 over a network 370 to provide a location-aware application such as a parallel reality game to a user at the client device 310. The networked computing environment 300 also may include other external systems such as sponsor/advertiser systems or business systems. Although only one client device 310 is shown in FIG. 3, any number of client devices 310 or other external systems may be connected to the server 320 over the network 370. Furthermore, the networked computing environment 300 may contain different or additional elements and functionality may be distributed between the client device 310 and the server 320 in different manners than described below.

The networked computing environment 300 provides for the interaction of client devices 310 with a location-aware application provided by the server 320. In a particular example, a geographic area in the real world can be linked or mapped directly to a corresponding area in the virtual world. A user can move about in the virtual world by moving to various geographic locations in the real world. For instance, a user's position in the real world can be tracked and used to update the user's position in the virtual world. Typically, the user's position in the real world is determined by finding the location of a client device 310 through which the user is interacting with the virtual world and assuming the player is at the same (or approximately the same) location. For example, in various embodiments, the user may interact with a virtual element if the user's location in the real world is within a threshold distance (e.g., ten meters, twenty meters, etc.) of the real-world location that corresponds to the virtual location of the virtual element in the virtual world. For convenience, various embodiments are described with reference to “the user's location” but one of skill in the art will appreciate that such references may refer to the location of the user's client device 310. Furthermore, the same or similar techniques may be provided for robots, vehicles, and other entities based on position data provided by sensers (e.g., cameras) of the entities.

A client device 310 can be any portable computing device capable for use by a user to interface with the server 320. For instance, a client device 310 is preferably a portable wireless device that can be carried by a user, such as a smartphone, portable gaming device, AR headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle or robot with a built-in computing device.

The client device 310 communicates with the server 320 to provide sensory data of a physical environment. In one embodiment, the client device 310 includes a camera assembly 312, an application module 314, a positioning module 316, a localization module 318, and a 3D scene reconstruction module 319. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The application module 314 provides a user (e.g., a player) with an interface to interact with a location-aware application (e.g., a parallel reality game). The server 320 transmits application data over the network 370 to the client device 310 for use by the application module 314 to provide a local version of the application to a user at locations remote from the server. In one embodiment, the application module 314 presents a user interface on a display of the client device 310 that depicts a virtual world (e.g., renders imagery of the virtual world) and allows a user to interact with the virtual world to perform various objectives. In some embodiments, the application module 314 presents images of the real world (e.g., captured by the camera assembly 312) augmented with virtual elements (e.g., AR elements) from the location-application application. In these embodiments, the application module 314 may generate or adjust virtual content according to other information received from other components of the client device 310. For example, the application module 314 may adjust a virtual object to be displayed on the user interface according to a depth map of the scene captured in the image data.

The application module 314 can also control various other outputs to allow a user to interact with the application without requiring the user to view a display screen. For instance, the application module 314 can control various audio, vibratory, or other notifications that allow the user to receive information from the location-aware application without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

In one embodiment, as the user moves around with the client device 310 in the real world, the positioning module 316 tracks the position of the user and provides the user position information to the application module 314. The application module 314 updates the user position in the virtual world based on the actual position of the user in the real world. Thus, a user can interact with the virtual world simply by carrying or transporting the client device 310 in the real world. In particular, the location of the user in the virtual world can correspond to the location of the user in the real world. The application module 314 can provide user position information to the server 320 over the network 370. In response, the server 320 may enact various techniques to verify the location of the client device 310 to prevent users from spoofing their locations (e.g., to cheat in a parallel reality game). It should be understood that location information associated with a user is utilized only if permission is granted after the user has been notified that location information of the user is to be accessed and how the location information is to be utilized in the context of the location-aware application (e.g., to update user position in the virtual world). In addition, any location information associated with users is stored and maintained in a manner to protect user privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the server 320. The 3D map may be a point cloud, mesh, Gaussian splat cloud, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device. In some embodiments, the 3D map used by the localization module 318 to localize the client device 310 may be generated based on the functionality provided by the 3D scene reconstruction module 319.

The 3D scene reconstruction module 319 may be configured to generate a three-dimensional scene representation from a single input image (e.g., a single RGB image) captured by the camera assembly 312. The 3D scene reconstruction module 319 may take the single input image as input and output a set of three-dimensional Gaussian splats representing the scene, including surfaces that are occluded or otherwise not visible in the input image. The three-dimensional Gaussian splats may be rendered from arbitrary viewpoints to provide novel view synthesis of the scene, enabling applications such as augmented reality visualization and VR-based exploration of real-world locations.

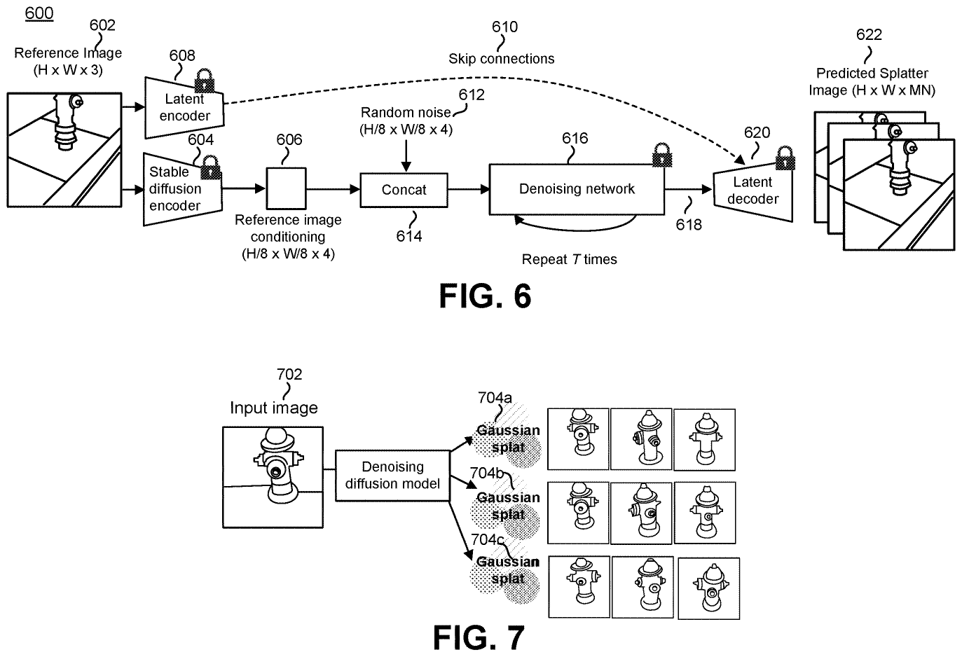

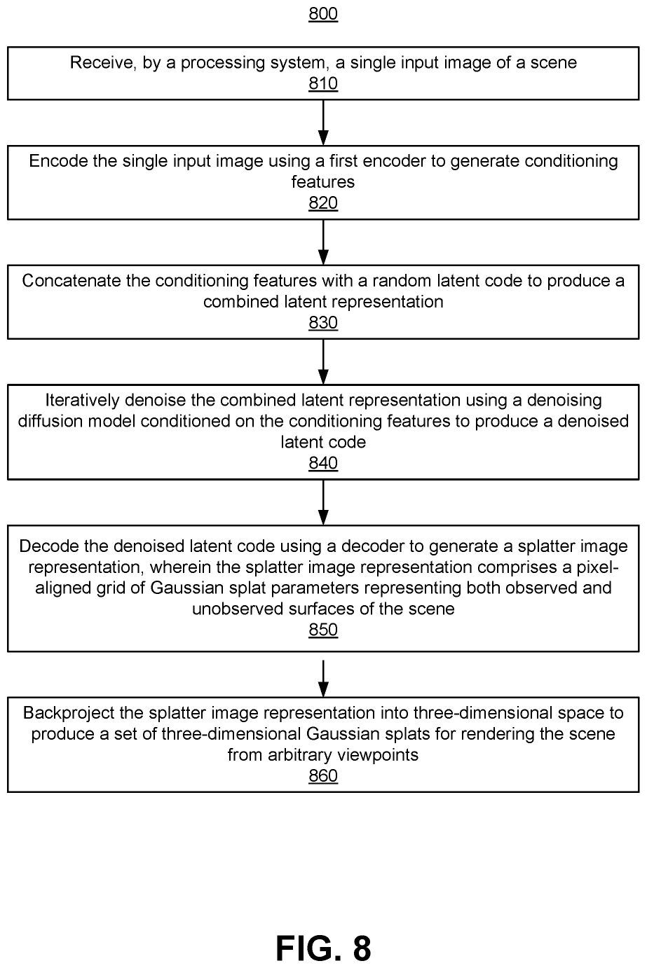

At a high level, the 3D scene reconstruction module 319 may encode the single input image using a first encoder to generate conditioning features, concatenate the conditioning features with a random latent code, and iteratively denoise the combined representation using a denoising diffusion model to produce a denoised latent code. A decoder may then transform the denoised latent code into a splatter image representation, which may be a pixel-aligned grid of Gaussian splat parameters representing both observed and unobserved surfaces of the scene. The splatter image representation may be backprojected into three-dimensional space to produce the set of three-dimensional Gaussian splats. Skip connection features derived from a second encoder may be provided to the decoder to preserve high-frequency detail from the input image. The inference pipeline of the 3D scene reconstruction module 319 is described in greater detail with respect to FIG. 6, and an associated method is described with respect to FIG. 8.

Because the 3D scene reconstruction module 319 uses a denoising diffusion model, the module may generate multiple diverse three-dimensional scene representations from the same single input image by initiating the denoising process from different random latent codes. Each resulting scene representation may provide a different plausible completion of the unobserved surfaces while maintaining consistency with the surfaces visible in the input image. This multi-modal capability is described in greater detail with respect to FIG. 7.

The denoising diffusion model and the encoder-decoder network used by the 3D scene reconstruction module 319 may be trained by the training module 328 of the server 320, as described further below with respect to the training module 328. Once trained, the model parameters may be transmitted to the client device 310 over the network 370 for use by the 3D scene reconstruction module 319 during inference.

In one embodiment, the localization module 318 applies a trained model to determine the pose of images captured by the camera assembly 312 relative to a 3D map, which may include the three-dimensional Gaussian splats generated by the 3D scene reconstruction module 319. Thus, the localization module 318 can make an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the application module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The server 320 includes one or more computing devices that provide application functionality to the client device 310. The server 320 can include or be in communication with a database 330. The database 330 stores application data used in the location-aware application to be served or provided to the client device 310 over the network 370.

The application data stored in the database 330 can include: (1) data associated with a virtual world (e.g., image data used to render the virtual world on a display device, geographic coordinates of locations in the virtual world, etc.); (2) data associated with users of the location-aware application (e.g., user profiles including user information, experience level, in-application currency, current user positions in the virtual world/real world, energy level, user preferences, team or other group information, etc.); (3) data associated with objectives (e.g., data associated with current objectives, status of objectives, past objectives, future objectives, desired objectives, etc.); (4) data associated with virtual elements in the virtual world (e.g., positions of virtual elements, types of virtual elements, objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) application status (e.g., current number of users, current status of objectives, user leaderboard, etc.); (7) data associated with user actions/input (e.g., current user positions, past user positions, user moves, user input, user queries, user communications, etc.); or (8) any other data used, related to, or obtained during implementation of the location-aware application. The application data stored in the database 330 can be populated either offline or in real time by system administrators or by data received from users (e.g., players), such as from a client device 310 over the network 370.

In one embodiment, the server 320 is configured to receive requests for application data from a client device 310 (for instance via remote procedure calls (RPCs)) and to respond to those requests via the network 370. The server 320 can encode application data in one or more data files and provide the data files to the client device 310. In addition, the server 320 can be configured to receive application data (e.g., user positions, user actions, user input, etc.) from a client device 310 via the network 370. The client device 310 can be configured to periodically send user input and other updates to the server 320, which the server uses to update application data in the database 330 to reflect any and all changed conditions for the location-aware application.

In the embodiment shown in FIG. 3, the server 320 includes a universal application module 321, a commercial integration module 323, a data collection module 324, an event module 326, a mapping system 327, a training module 328, and a 3D map store 329. As mentioned above, the server 320 interacts with a database 330 that may be part of the server or accessed remotely (e.g., the database 330 may be a distributed database accessed via the network 370). In other embodiments, the server 320 contains different or additional elements. In addition, the functions may be distributed among the elements in a different manner than described.

The universal application module 321 hosts an instance of the location-aware application (e.g., a parallel reality game) for a set of users (e.g., all users of the location-aware application) and acts as the authoritative source for the current status of the location-aware application for the set of users. As the host, the universal application module 321 generates application content for presentation to users (e.g., via their respective client devices 310). The universal application module 321 may access the database 330 to retrieve or store application data when hosting the location-aware application. The universal application module 321 may also receive application data from client devices 310 (e.g., depth information, user input, user position, user actions, landmark information, etc.) and incorporates the application data received into the overall location-aware application for the entire set of users. The universal application module 321 can also manage the delivery of application data to the client device 310 over the network 370. In some embodiments, the universal application module 321 also governs security aspects of the interaction of the client device 310 with the location-aware application, such as securing connections between the client device and the server 320, establishing connections between various client devices, or verifying the location of the various client devices 310 (e.g., to prevent players of a parallel-reality game from cheating by spoofing their location).

The commercial integration module 323 manages the inclusion of various application features within the location-aware application that are linked with a commercial activity in the real world. For instance, the commercial integration module 323 can receive requests from external systems such as sponsors/advertisers, businesses, or other entities over the network 370 to include application features linked with commercial activity in the real world. The commercial integration module 323 can then arrange for the inclusion of these application features in the location-aware application on confirming the linked commercial activity has occurred. For example, if a business pays the provider of a parallel reality game an agreed upon amount, a virtual object identifying the business may appear in the parallel reality game at a virtual location corresponding to a real-world location of the business (e.g., a store or restaurant).

The data collection module 324 manages the inclusion of various application features within the location-aware application that are linked with a data collection activity in the real world. For instance, the data collection module 324 can modify application data stored in the database 330 to include game features linked with data collection activity in a parallel reality game. The data collection module 324 can also analyze data collected by users pursuant to the data collection activity and provide the data for access by various platforms.

The event module 326 manages user access to events in the location-aware application. Although the term “event” is used for convenience, it should be appreciated that this term need not refer to a specific event at a specific location or time. Rather, it may refer to any provision of access-controlled application content where one or more access criteria are used to determine whether users may access that content. Such content may be part of a larger location-aware application that includes content with less or no access control or may be a stand-alone, access controlled location-based application.

The mapping system 327 generates a 3D map of a geographical region based on a set of images. In some embodiments, the mapping system 327 may subsume some or all of the functionality of the 3D scene reconstruction module 319. The 3D map may be a point cloud, polygon mesh, a set of Gaussian splats, or any other suitable representation of the 3D geometry of the geographical region. The 3D map may include semantic labels providing additional contextual information, such as identifying objects (tables, chairs, clocks, lampposts, trees, etc.), materials (concrete, water, brick, grass, etc.), or properties (e.g., traversable by characters, suitable for certain actions, etc.). In one embodiment, the mapping system 327 stores the 3D map (e.g., a set of three-dimensional Gaussian splats generated from a single input image by the 3D scene reconstruction module 319) along with any semantic or contextual information in the 3D map store 329. The 3D map may be stored in the 3D map store 329 in conjunction with location information (e.g., GPS coordinates of the center of the 3D map, a ringfence defining the extent of the 3D map, or the like). Thus, the server 320 can provide the 3D map to client devices 310 that provide location data indicating they are within or near the geographic area covered by the 3D map.

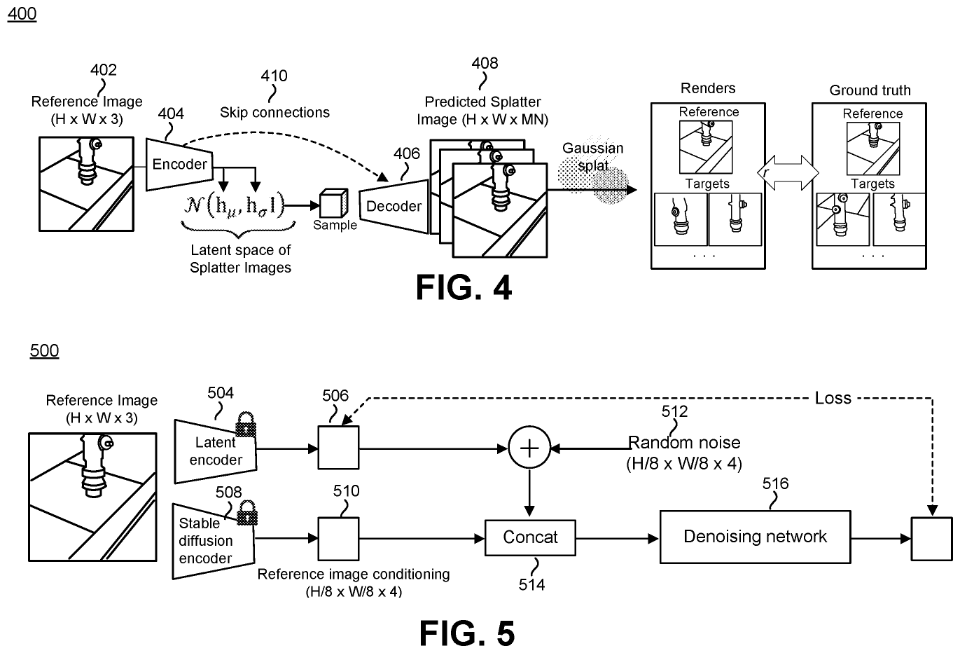

The training module 328 trains the denoising diffusion model and the encoder-decoder network used by the 3D scene reconstruction module 319 of the client device 310. The training module 328 may train these models using a two-step process. In a first training step, the training module 328 may train an encoder-decoder network to learn a latent space of splatter image representations using self-supervised losses, as described in greater detail with respect to FIG. 4. In a second training step, the training module 328 may train a denoising diffusion model on latent codes produced by the trained encoder-decoder network, as described in greater detail with respect to FIG. 5. Although the training module 328 is shown as part of the server 320 for convenience, the training functionality may be provided by another system or systems. For example, the models may be trained by a development system and incorporated in an application that is downloaded to client devices 310 from an app store, or the trained model parameters may be transmitted to client devices 310 over the network 370.

The first training step may involve training an encoder-decoder network using a training dataset that includes multiple image sequences capturing different scenes, where each training example includes a reference image, a set of target images (ground truth) captured from different viewpoints, and corresponding target camera poses and intrinsics. The encoder may process a reference image to produce a latent code representing the scene in a compressed form. The decoder may convert the latent code into a splatter image representation, which may be backprojected into three-dimensional space as Gaussian splats and rendered from the target camera poses. The rendered images may be compared to the corresponding ground truth target images to compute self-supervised reconstruction losses that guide the training. Skip connections from the encoder to the decoder may be used to preserve high-frequency detail, and these skip connections may be randomly zeroed out during training to ensure that the latent codes capture sufficient scene information for subsequent use by the denoising diffusion model.

The second training step may involve training the denoising diffusion model on the latent codes produced by the encoder-decoder network trained in the first step. The training module 328 may encode images from the training dataset using the trained encoder to generate ground truth latent codes. Noise may be added to these latent codes according to a variance schedule, and the denoising diffusion model may be trained to predict and remove the added noise. To condition the denoising process on the input image, conditioning features extracted from the input image using a pre-trained encoder (e.g., a Stable Diffusion encoder) may be concatenated with the noisy latent codes and provided as input to the denoising network. The training module 328 may also incorporate classifier-free guidance by omitting the conditioning features for a portion of the training steps (e.g., 20% of the time), which may encourage the model to generate diverse predictions for unobserved surfaces rather than overfitting to the appearance of the input image.

Once training is complete, the trained encoder-decoder network and denoising diffusion model may be deployed to client devices 310 for use by the 3D scene reconstruction module 319 during inference. The 3D map store 329 may store three-dimensional Gaussian splat scene representations generated by the 3D scene reconstruction module 319 or the mapping system 327, making them available to client devices 310 that are within or near the corresponding geographic area.

The network 370 can be any type of communications network, such as a local area network (e.g., an intranet), wide area network (e.g., the internet), or some combination thereof. The network can also include a direct connection between a client device 310 and the server 320. In general, communication between the server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Training Pipelines

As introduced above with respect to the training module 328 (FIG. 3), the denoising diffusion model and the encoder-decoder network used by the 3D scene reconstruction module 319 may be trained using a two-step training process. FIG. 4 illustrates the first training step, in which an encoder-decoder network is trained to learn a latent space of splatter image representations. FIG. 5 illustrates the second training step, in which a denoising diffusion model is trained on latent codes produced by the encoder-decoder network of FIG. 4. The disclosed two-step training process may address a challenge in applying denoising diffusion models to Gaussian splat generation: conventional denoising diffusion models require ground truth samples to which noise is progressively added during forward diffusion, which requires a large dataset of pre-computed splatter image representations. However, splatter image representations are typically learned via self-supervision from posed two-dimensional images rather than from explicit three-dimensional ground truth. The two-step approach resolves this by first learning a latent space through self-supervised training, thereby generating latent codes that can serve as the ground truth samples for training the denoising diffusion model in the second step.

FIG. 4 illustrates a training pipeline 400 for the first training step, in which an encoder-decoder network is trained end-to-end on scenes with multiple posed images to learn a low-dimensional latent representation of splatter image representations. The training pipeline 400 may be executed by the training module 328 of the server 320, or by another computing system as described above.

The training pipeline 400 may operate on a training dataset that includes multiple image sequences capturing different object instances and scenes. Each training example may comprise a reference image, a set of target images captured from different viewpoints of the same scene, and corresponding camera poses and intrinsics for each image. For example, the training dataset may include video captures of various objects in real-world contexts, where camera extrinsics and intrinsics are recovered using structure-from-motion (SfM). The training data may be collected by users of the client devices 310, for example through the data collection module 324, or may be obtained from other sources.

Referring to FIG. 4, a reference image 402 (having dimensions H×W×3 for an RGB image) is provided as input to an encoder 404. The encoder 404 processes the reference image 402 and produces parameters for a variational distribution over the latent space. Specifically, the encoder 404 may output mean and variance parameters that define a normal distribution over the latent space of splatter image representations. A latent code may then be sampled from this distribution using a reparameterization trick, which allows gradients to flow through the sampling operation during training. In some embodiments, the encoder 404 may predict the latent representation at ⅛ of the resolution of the reference image 402 with 4+4 channels (4 channels for the mean and 4 channels for the variance), resulting in a latent code of dimensions H/8×W/8×4.

The sampled latent code is passed to a decoder 406, which converts the latent code into a splatter image representation 408. The splatter image representation 408 may be a pixel-aligned grid of Gaussian splat parameters having dimensions H×W×MN, where M represents the number of Gaussian splats predicted per pixel and N represents the number of parameters per Gaussian splat. In one embodiment, N equals 15 scalar values per Gaussian splat, including parameters for a three-dimensional position (computed from predicted pixel depth and a three-dimensional offset), an opacity value, color coefficients (e.g., modeled with spherical harmonics, using DC coefficients), and scale and rotation parameters of a covariance matrix. The value of M may be an integer greater than or equal to one; when M is greater than one, the decoder 406 predicts multiple Gaussian splats per pixel, which may encourage the network to model occluded surfaces that are not directly visible from the viewpoint of the reference image 402.

The encoder-decoder architecture of the encoder 404 and decoder 406 may follow an architecture similar to that of Stable Diffusion or another suitable variational autoencoder architecture. The encoder 404 and decoder 406 together form a variational autoencoder (VAE) whose bottleneck corresponds to the latent space of splatter image representations. A KL-divergence loss may be applied to regularize the distribution of the latent space, encouraging the latent space to conform to a standard normal prior distribution. This regularization may make the latent space more compact and well-structured, which may facilitate subsequent training of the denoising diffusion model in the second training step.

The training pipeline 400 may include skip connections 410 that allow high-frequency information to flow directly from early layers of the encoder 404 to corresponding higher-resolution layers of the decoder 406. The skip connections 410 may address a technical limitation of the low-dimensional latent representation: because the latent code may be, e.g., compressed to ⅛ resolution with only 4 channels, it may not fully capture fine-grained details of the scene that are visible in the reference image 402, such as textures, edges, and other high-frequency features. By providing the decoder 406 with access to feature maps from the encoder's first layer (or other early layers) via the skip connections 410, the decoder 406 may produce splatter image representations 408 with improved sharpness and fidelity to the visible surfaces of the reference image 402.

However, the skip connections 410 may create a risk that the encoder-decoder network learns to route the majority of scene information through the skip connection features rather than through the latent code. If this occurs, the latent code may fail to encapsulate meaningful information about the scene, which would undermine the ability of the denoising diffusion model (trained in the second step) to generate diverse and plausible scene completions by operating on the latent codes. To mitigate this, the training pipeline 400 may randomly zero out the skip connection features during training. For example, during a given training iteration, the values of the skip connection features may be set to zero with some probability, forcing the encoder-decoder network to encode scene information into the latent code rather than relying exclusively on the skip connections 410. This dropout-based regularization of the skip connections 410 may ensure that the latent codes capture sufficient scene information to support the denoising diffusion model while still allowing the skip connections 410 to contribute high-frequency detail when they are active.

The predicted splatter image representation 408 may be converted into a Gaussian splat representation of the scene by backprojecting the pixel-aligned Gaussian splat parameters into three-dimensional space using the known camera intrinsics of the reference image 402. The resulting three-dimensional Gaussian splats may then be rendered into RGB images from the camera poses of both the reference image 402 and each target image in the training example. The rendering may use differentiable Gaussian splatting, which projects the three-dimensional Gaussian splats onto the image plane of the desired viewpoint to produce a rendered image.

A reconstruction loss may then be computed by comparing the rendered images to the corresponding ground truth images (i.e., the reference image 402 and the target images in the training examples). The reconstruction loss may comprise a combination of multiple loss terms, including a pixel-wise L2 loss that measures the mean squared error between the rendered and ground truth images, a structural similarity (SSIM) loss that encourages similarity in structure and contrast between the rendered and ground truth images, and a learned perceptual image patch similarity (LPIPS) loss that compares neural network encodings of image patches to encourage photorealism in the rendered output. The loss terms may be weighted by respective coefficients. In one embodiment, the training pipeline 400 may first train the encoder-decoder network using a combination of L2 and SSIM losses, and then fine-tune with an additional LPIPS loss. Because the reconstruction loss is computed by rendering the predicted Gaussian splats from the target camera poses and comparing to the ground truth target images, the training is self-supervised in the sense that it does not require explicit three-dimensional ground truth; instead, it relies only on posed two-dimensional RGB images.

Color augmentation may be applied to both the reference image 402 and the target images during training. The same color transform may be applied to both the reference and target images within a given training example to preserve the validity of the self-supervised reconstruction losses. The augmentation may improve the robustness of the trained encoder-decoder network to variations in lighting and color conditions.

By the end of the first training step, the encoder 404 may be capable of encoding any input image into a compact latent code that captures information about both the visible and hidden surfaces of the scene, and the decoder 406 may be capable of converting such a latent code (together with skip connection features when available) into a splatter image representation that, when backprojected and rendered, provides a plausible reconstruction of the scene from multiple viewpoints.

FIG. 5 illustrates a training pipeline 500 for the second training step, in which a denoising diffusion model is trained on latent codes produced by the encoder-decoder network trained in the first step (FIG. 4). The training pipeline 500 may be executed by the training module 328 of the server 320, or by another computing system.

Once the encoder-decoder network from the first training step is trained, the encoder 404 may be applied to each image in the training dataset to generate a corresponding latent code. These latent codes serve as the ground truth samples for training the denoising diffusion model. The latent codes may be sampled from the variational distribution produced by the encoder 404 (i.e., sampled from the learned normal distribution using the reparameterization trick), rather than using the mean directly, which may introduce beneficial diversity in the ground truth latent codes used for diffusion training.

Referring to FIG. 5, a reference image 502 (having the same dimensions H×W×3 as in FIG. 4) is processed by two separate encoders. A latent encoder 504, which is the same encoder 404 trained in the first step (and may be frozen during the second training step), may process the reference image 502 to produce a ground truth latent code 506. Separately, a conditioning encoder 508 (e.g., a pre-trained Stable Diffusion VAE encoder) may process the reference image 502 to produce conditioning features 510. The conditioning features 510 may have dimensions, e.g., H/8×W/8×4 and may capture visual characteristics of the reference image 502 in a format suitable for conditioning the denoising process. The latent encoder 504 and the conditioning encoder 508 are different networks serving different purposes: the latent encoder 504 produces the ground truth latent code that the denoising diffusion model will learn to reconstruct, while the conditioning encoder 508 produces features that inform the denoising network about the appearance of the input image.

The training pipeline 500 may apply a forward diffusion process to the ground truth latent code 506 by adding random noise 512 according to a variance schedule. The variance schedule defines a sequence of noise parameters that control the amount of noise added at each diffusion time step. At a given time step t (uniformly sampled during training), the noise is scaled and combined with the ground truth latent code to produce a noisy latent code, where higher time steps correspond to greater levels of noise corruption.

The noisy latent code is concatenated with the conditioning features 510 produced by the conditioning encoder 508 at a concatenation operation 514 to form a combined input to a denoising network 516. The denoising network 516 takes as input the concatenated noisy latent code and conditioning features, along with the time step t, and is trained to predict the noise that was added to the ground truth latent code 506. The training objective minimizes a denoising loss, which may be the squared difference between the predicted noise and the actual noise that was added. By learning to predict and remove the noise at various noise levels (corresponding to different time steps), the denoising network 516 learns to progressively refine noisy latent codes into clean latent codes that represent plausible scene completions.

The training pipeline 500 may incorporate classifier-free guidance to improve the diversity of scene completions generated by the trained model. During training, the conditioning features 510 may be omitted (e.g., replaced with zeros or null values) for a fraction of the training iterations. In one embodiment, the conditioning features 510 may be omitted approximately 20% of the time, effectively training the denoising network 516 to perform both conditional denoising (conditioned on the input image features) and unconditional denoising (without reference to the input image). This classifier-free guidance training may reduce the tendency of the model to overfit to the scene appearance visible in the conditioning view, thereby enabling the generation of more diverse predictions for unobserved surfaces at inference time.

The denoising network 516 may follow an architecture similar to that used in Stable Diffusion or Marigold, adapted for operating on the latent codes of splatter image representations. The denoising network 516 may be a U-Net or similar architecture that accepts the concatenated input and a time step embedding and outputs a noise prediction of the same dimensionality as the latent code.

The training pipeline 500 may use an Adam optimizer with a learning rate and an exponential learning rate scheduler. The denoising diffusion model may be trained for a large number of steps (e.g., 1,000,000 steps) with a suitable batch size (e.g., 32) to ensure convergence. These training hyperparameters may be adjusted based on the specific dataset and computational resources available.

Upon completion of the second training step, the trained denoising network 516, together with the conditioning encoder 508, the decoder 406 from the first training step, and the skip connection pathway from the encoder 404, may form the complete inference pipeline used by the 3D scene reconstruction module 319 of the client device 310. The trained model parameters may be deployed to client devices 310 as described above with respect to FIG. 3. The inference pipeline is described in greater detail with respect to FIG. 6.

### Example Inference Pipeline

FIG. 6 illustrates an inference pipeline 600 for generating a splatter image representation from a single input image using the trained denoising diffusion model and encoder-decoder network described above with respect to FIGS. 4 and 5. The inference pipeline 600 may be executed by the 3D scene reconstruction module 319 of the client device 310, or by another suitable computing system. At inference time, the inference pipeline 600 receives a single input image of a scene and produces a set of three-dimensional Gaussian splats representing the complete scene, including surfaces that are occluded or otherwise not visible in the input image.

Referring to FIG. 6, a reference image 602 (having dimensions H×W×3 for an RGB image) is provided as input to the inference pipeline 600. The reference image 602 may be a single image captured by the camera assembly 312 of the client device 310, or may be obtained from another source such as the database 330 or an external image repository. Unlike the training pipelines described with respect to FIGS. 4 and 5, the inference pipeline 600 does not require multiple posed images of the scene or any ground truth target images. A single image is sufficient to generate a complete three-dimensional scene representation.

The reference image 602 may be processed by two separate encoders. A conditioning encoder 604 (e.g., the same pre-trained Stable Diffusion VAE encoder used as the conditioning encoder 508 during training) may encode the reference image 602 to produce conditioning features 606. The conditioning features 606 may have, e.g., dimensions H/8 x W/8 x 4 and capture visual characteristics of the reference image 602 that will guide the denoising process to produce a scene representation consistent with the input image. The conditioning encoder 604 (e.g., first encoder) may serve as the source of the conditioning features that are concatenated with the random latent code and that condition the denoising diffusion model throughout the iterative denoising process.

Separately, a latent encoder 608 (e.g., the same encoder 404 trained in the first training step described with respect to FIG. 4) may encode the reference image 602 to produce skip connection features 610. The skip connection features 610 may be derived from early layers of the latent encoder 608 (e.g., second encoder) and capture high-frequency spatial detail from the reference image 602, such as textures, edges, and fine-grained color information. During inference, the latent encoder 608 may not produce a latent code that is used directly in the denoising process (as this role is filled by the random latent code); rather, the latent encoder 608 may provide the skip connection features 610 that are passed to the decoder to improve the fidelity of the output to the visible surfaces of the reference image 602.

The inference pipeline 600 may generate a random latent code 612, which may be sampled from a standard normal distribution. The random latent code 612 may have dimensions matching those of the latent codes produced during training (e.g., H/8×W/8×4). The random latent code 612 may serve as the starting point for the iterative denoising process and is the source of stochasticity that enables the generation of diverse scene completions, as discussed further below with respect to FIG. 7.

The random latent code 612 may be concatenated with the conditioning features 606 at a concatenation operation 614 to produce a combined latent representation. This combined latent representation may be provided as input to a denoising network 616 (e.g., the same denoising network 516 trained in the second training step described with respect to FIG. 5). The denoising network 616 may iteratively process the combined latent representation over a series of T denoising steps (e.g., 50 steps), progressively removing noise and refining the latent code at each step. At each iteration, the denoising network 616 may predict the noise component of the current latent representation and subtract it, producing a cleaner latent representation that is then used as input for the next iteration. The conditioning features 606 may be provided to the denoising network 616 at each iteration, ensuring that the denoising process remains conditioned on the visual content of the reference image 602 throughout.

At inference time, a classifier-free guidance weight may be applied to control the balance between fidelity of the output to the reference image 602 and diversity of completions for unobserved surfaces. The classifier-free guidance mechanism may leverage the conditional and unconditional denoising capabilities learned during training (as described with respect to FIG. 5). A higher classifier-free guidance weight may increase diversity in the predicted unobserved surfaces, while a lower weight may produce outputs that more closely follow the conditioning features derived from the reference image 602. The classifier-free guidance weight may be adjusted at inference time without requiring retraining of the denoising network 616, providing a flexible control parameter for different application scenarios.

After the T denoising iterations are complete, the denoising network 616 may output a denoised latent code 618. The denoised latent code 618 may represent a compact encoding of the complete scene, including both the surfaces visible in the reference image 602 and plausible completions of the unobserved surfaces.

The denoised latent code 618, together with the skip connection features 610 from the latent encoder 608, may be provided to a decoder 620 (e.g., the same decoder 406 trained in the first training step described with respect to FIG. 4). The decoder 620 may ingest the denoised latent code 618 as its primary input and receives the skip connection features 610 as an auxiliary input. The skip connection features 610 allow the decoder 620 to incorporate high-frequency detail from the reference image 602 that may not be fully captured in the denoised latent code 618 due to the compression of the latent representation. The decoder 620 may produce a splatter image representation 622, which may be a pixel-aligned grid of Gaussian splat parameters having dimensions H×W×MN, as described above with respect to FIG. 4.

At inference time, a skip connection weight may be applied to the skip connection features 610 to control the degree to which the decoder 620 relies on the high-frequency detail from the reference image 602. A higher skip connection weight may produce outputs with greater fidelity to the appearance of the reference image 602, particularly for the visible surfaces of the scene. A lower skip connection weight may allow the decoder 620 to rely more heavily on the denoised latent code 618, which may increase diversity in the predicted surfaces at the expense of some high-frequency detail. The skip connection weight and the classifier-free guidance weight described above may be adjusted independently, providing two separate control parameters that may be tuned to balance reconstruction fidelity and sample diversity for a given application. These weights may be adjusted without retraining the model.

The splatter image representation 622 output by the decoder 620 comprises a pixel-aligned grid in which each pixel location stores the parameters of one or more Gaussian splats. As described with respect to FIG. 4, each Gaussian splat may be defined by a set of parameters including a three-dimensional position, an opacity value, color coefficients, and scale and rotation parameters of a covariance matrix. The three-dimensional position of each Gaussian splat may be computed from a predicted pixel depth and a three-dimensional offset relative to the pixel's camera ray. The splatter image representation 622 thus encodes a complete scene representation in a structured, pixel-aligned format that facilitates efficient conversion to a three-dimensional Gaussian splat scene.

The splatter image representation 622 is backprojected into three-dimensional space using the known or estimated camera intrinsics associated with the reference image 602 to produce a set of three-dimensional Gaussian splats. The backprojection process converts the two-dimensional pixel coordinates and predicted depth values of each Gaussian splat into three-dimensional world coordinates, placing each splat at its corresponding position in three-dimensional space. The resulting set of three-dimensional Gaussian splats may then be rendered from arbitrary viewpoints using Gaussian splatting, which projects the three-dimensional Gaussian splats onto the image plane of a desired viewpoint to produce a rendered image. Because Gaussian splatting is a computationally efficient rendering technique, the three-dimensional Gaussian splats may support real-time novel view synthesis, enabling interactive applications such as augmented reality overlays, VR-based exploration of real-world locations, and head-mounted display experiences where a user may move their viewpoint freely within the reconstructed scene.

FIG. 7 illustrates the generation of multiple diverse three-dimensional scene representations from a single input image using the inference pipeline 600 of FIG. 6. As described above, the inference pipeline 600 begins from a random latent code 612 sampled from a standard normal distribution. Because different random latent codes represent different starting points in the latent space, each run of the inference pipeline 600 with a different random latent code may converge to a different region of the latent space during the iterative denoising process, resulting in a different splatter image representation and, consequently, a different three-dimensional Gaussian splat scene.

Referring to FIG. 7, a single input image 702 is provided to the inference pipeline 600 (e.g., the denoising diffusion model of the 3D scene reconstruction module 319). The inference pipeline 600 is executed multiple times, each time using a different random latent code as the starting point. Each execution produces a different set of three-dimensional Gaussian splats (e.g., Gaussian splat scene 704a, Gaussian splat scene 704b, Gaussian splat scene 704c), where each scene represents a complete three-dimensional reconstruction of the scene depicted in the input image 702. Each of the Gaussian splat scenes 704a, 704b, 704c is a standalone three-dimensional scene representation that may be independently rendered from arbitrary viewpoints.

The multiple Gaussian splat scenes 704a, 704b, 704c generated from the same input image 702 may share common characteristics in regions corresponding to surfaces that are directly visible in the input image 702, because the conditioning features derived from the input image 702 and the skip connection features guide the denoising process to maintain consistency with the observed surfaces. However, the Gaussian splat scenes 704a, 704b, 704c may differ from one another in regions corresponding to unobserved surfaces, such as the back sides of objects, areas occluded by foreground objects, or regions outside the camera's field of view. Each scene represents a different plausible completion of these unobserved regions. This multi-modal behavior arises naturally from the diffusion-based architecture, in which the random latent code determines which mode of the output distribution the denoising process converges to.

The number of distinct scene representations generated from a single input image is not limited to any particular value. The inference pipeline 600 may be executed any number of times with different random latent codes to produce an arbitrary number of diverse scene completions. FIG. 7 illustrates three such scene representations for purposes of example, but more or fewer may be generated depending on the application requirements.

The degree of diversity among the generated scene representations may be controlled through the classifier-free guidance weight and the skip connection weight described above with respect to FIG. 6. A configuration with a higher classifier-free guidance weight and a lower skip connection weight may produce scene representations with greater diversity in the unobserved regions, while a configuration with a lower classifier-free guidance weight and a higher skip connection weight may produce scene representations that are more similar to one another and more faithful to the appearance of the input image 702.

In some embodiments, the 3D scene reconstruction module 319 may generate a single three-dimensional scene representation by executing the inference pipeline 600 once with a single random latent code. Even a single sample benefits from the diffusion-based approach, because the denoising process may commit to a single coherent mode of the output distribution rather than averaging across all possible modes, resulting in sharper and more plausible completions of unobserved surfaces compared to regression-based methods that produce a single deterministic output.

In other embodiments, the 3D scene reconstruction module 319 may generate multiple scene representations and select one based on a quality metric, user preference, or other selection criterion. For example, the 3D scene reconstruction module 319 may generate a plurality of candidate scene representations, evaluate each candidate against one or more quality measures (e.g., perceptual quality, geometric consistency, or a learned quality score), and select the highest-scoring candidate for use in downstream applications such as rendering, localization, or augmented reality visualization. Alternatively, the multiple scene representations may be presented to a user (e.g., via the application module 314 or a VR/AR interface), allowing the user to select a preferred scene completion.

The multi-modal sampling capability described with respect to FIG. 7 may be particularly beneficial in scenarios where the unobserved portions of the scene are highly ambiguous. For example, when the input image 702 captures only the front of an object (e.g., a statue, a building facade, or a piece of furniture), the back of the object may have many plausible appearances. By generating multiple scene representations, the system provides a range of plausible completions rather than committing to a single potentially incorrect prediction. This capability may be useful in applications such as spatial computing, where a user exploring a scene in VR or AR may benefit from viewing different plausible reconstructions, or in content creation, where an artist or designer may select from among multiple generated completions.

### Example Methods

FIG. 8 is a flowchart describing an example method 800 for generating a three-dimensional scene representation from a single input image using Gaussian splats combined with denoising diffusion models, according to one embodiment. The steps of FIG. 8 are illustrated from the perspective of the 3D scene reconstruction module 319 of the client device 310 performing the method 800. However, some or all of the steps may be performed by other entities or components, such as the server 320 or another computing system. In addition, some embodiments may perform the steps in parallel, perform the steps in different orders, or perform different steps. In some embodiments, the method 800 may correspond to the inference pipeline 600 described above with respect to FIG. 6.

At step 810, the 3D scene reconstruction module 319 may receive a single input image of a scene. The single input image may be an RGB image captured by the camera assembly 312 of the client device 310, as described with respect to FIG. 3. The single input image may depict any scene, such as an outdoor environment, an indoor room, a landmark, or an object of interest. The single input image serves as the sole visual input from which the method 800 generates a complete three-dimensional scene representation, including surfaces that are not visible in the input image.

At step 820, the 3D scene reconstruction module 319 may encode the single input image using a first encoder to generate conditioning features. The first encoder may be the conditioning encoder 604 described with respect to FIG. 6 (e.g., a pre-trained Stable Diffusion VAE encoder). The conditioning features (e.g., conditioning features 606 of FIG. 6) may capture visual characteristics of the input image in a compressed latent format and may be used to condition the denoising diffusion model throughout the subsequent denoising process, ensuring that the generated scene representation remains consistent with the content of the input image.

At step 830, the 3D scene reconstruction module 319 may concatenate the conditioning features with a random latent code to produce a combined latent representation. The random latent code (e.g., random latent code 612 of FIG. 6) may be sampled from a standard normal distribution and serve as the stochastic starting point for the denoising process. The concatenation (e.g., at concatenation operation 614 of FIG. 6) may combine the conditioning features with the random latent code into a single tensor that is provided as input to the denoising diffusion model. As described with respect to FIG. 7, using a different random latent code at this step may produce a different three-dimensional scene representation, enabling multi-modal sampling of diverse scene completions.

At step 840, the 3D scene reconstruction module 319 may iteratively denoise the combined latent representation using a denoising diffusion model conditioned on the conditioning features to produce a denoised latent code. The denoising diffusion model (e.g., denoising network 616 of FIG. 6) may process the combined latent representation over a plurality of denoising iterations (e.g., 50 steps), progressively removing noise and refining the latent representation at each step. The conditioning features generated at step 820 may be provided to the denoising diffusion model at each iteration to maintain consistency with the input image. A classifier-free guidance weight may be applied during this step to control the balance between fidelity to the input image and diversity of completions for unobserved surfaces, as described with respect to FIG. 6. The denoising diffusion model may be the denoising network 516 trained in the second training step described with respect to FIG. 5.

At step 850, the 3D scene reconstruction module 319 may decode the denoised latent code using a decoder to generate a splatter image representation. The decoder (e.g., decoder 620 of FIG. 6, which corresponds to decoder 406 trained in the first training step of FIG. 4) may transform the denoised latent code into a splatter image representation (e.g., splatter image representation 622 of FIG. 6). The splatter image representation comprises a pixel-aligned grid of Gaussian splat parameters representing both observed and unobserved surfaces of the scene. Each pixel location in the grid may store the parameters of one or more Gaussian splats, including a three-dimensional position, an opacity value, color coefficients, and scale and rotation parameters, as described with respect to FIG. 4. In some embodiments, the decoder may also receive skip connection features (e.g., skip connection features 610 of FIG. 6) derived from a second encoder (e.g., latent encoder 608 of FIG. 6) to preserve high-frequency detail from the input image. A skip connection weight may be applied to control the degree to which the decoder relies on these features, as described with respect to FIG. 6.

At step 860, the 3D scene reconstruction module 319 may backproject the splatter image representation into three-dimensional space to produce a set of three-dimensional Gaussian splats for rendering the scene from arbitrary viewpoints. The backprojection converts the two-dimensional pixel coordinates and predicted depth values of each Gaussian splat in the splatter image representation into three-dimensional world coordinates using the known or estimated camera intrinsics associated with the input image. The resulting set of three-dimensional Gaussian splats (e.g., one of the sets 704a, 704b, 704c in FIG. 7) may form a complete scene representation that may be rendered from arbitrary viewpoints using Gaussian splatting. The three-dimensional Gaussian splats may be stored in the 3D map store 329 for subsequent use, provided to the localization module 318 for pose estimation, or rendered by the application module 314 for augmented reality or virtual reality applications, as described with respect to FIG. 3.

### Example Computing System

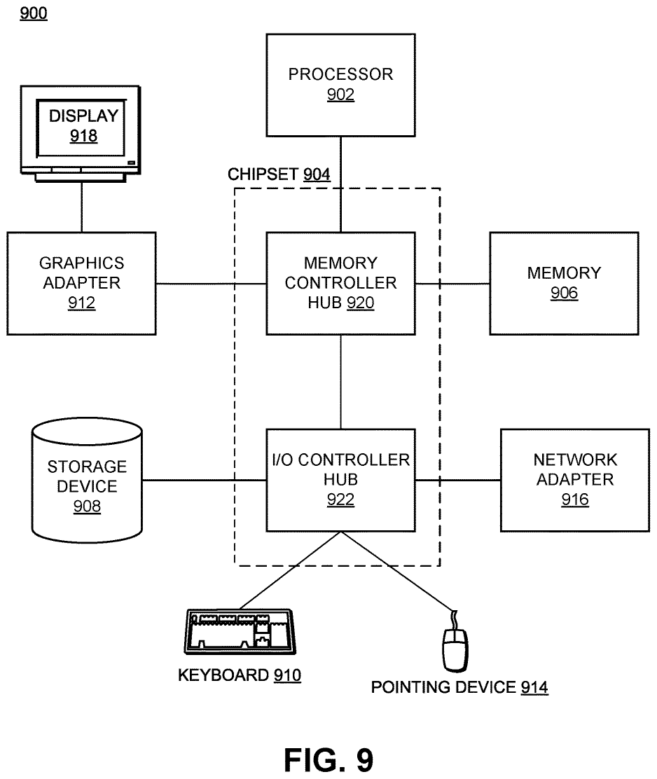

FIG. 9 is a block diagram of an example computer 900 suitable for use as a client device 310 or server 320. The example computer 900 includes at least one processor 902 coupled to a chipset 904. References to a processor (or any other component of the computer 900) should be understood to refer to any one such component or combination of such components working cooperatively to provide the described functionality. The chipset 904 includes a memory controller hub 920 and an input/output (I/O) controller hub 922. A memory 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

In the embodiment shown in FIG. 9, the storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, touch-screen, or other type of pointing device, and may be used in combination with the keyboard 910 (which may be an on-screen keyboard) to input data into the computer system 900. The graphics adapter 912 displays images and other information on the display 918. The network adapter 916 couples the computer system 900 to one or more computer networks, such as network 370.

The types of computers used by the entities of FIG. 3 can vary depending upon the embodiment and the processing power required by the entity. For example, the server 320 might include multiple blade servers working together to provide the functionality described. Furthermore, the computers can lack some of the components described above, such as keyboards 910, graphics adapters 912, and displays 918.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A method for generating a three-dimensional scene representation from a single input image, the method comprising:
receiving, by a processing system, a single input image of a scene;
encoding the single input image using a first encoder to generate conditioning features;
concatenating the conditioning features with a random latent code to produce a combined latent representation;
iteratively denoising the combined latent representation using a denoising diffusion model conditioned on the conditioning features to produce a denoised latent code;
decoding the denoised latent code using a decoder to generate a splatter image representation, wherein the splatter image representation comprises a pixel-aligned grid of Gaussian splat parameters representing both observed and unobserved surfaces of the scene; and
backprojecting the splatter image representation into three-dimensional space to produce a set of three-dimensional Gaussian splats for rendering the scene from arbitrary viewpoints.

2. The method of claim 1, wherein the decoder receives, in addition to the denoised latent code, skip connection features derived from a second encoder that encodes the single input image, the skip connection features providing high-frequency detail from the single input image to the decoder to improve fidelity of the splatter image representation to visible surfaces of the scene.

3. The method of claim 2, wherein the denoising diffusion model is trained by a process comprising:
training an encoder-decoder network using self-supervised losses computed by rendering predicted Gaussian splats from a plurality of target camera poses and comparing rendered images to corresponding ground truth images captured from those poses, thereby learning a latent space of splatter image representations; and
training the denoising diffusion model on latent codes produced by the trained encoder-decoder network, wherein training the denoising diffusion model comprises adding noise to the latent codes and training a denoising network to predict and remove the added noise.

4. The method of claim 3, wherein training the encoder-decoder network comprises:
randomly zeroing out the skip connection features during training to prevent the encoder-decoder network from encoding scene information exclusively in the skip connection features and to ensure that the latent codes capture scene information sufficient for the denoising diffusion model.

5. The method of claim 2, further comprising:
adjusting, at inference time, a weight applied to the skip connection features to control a degree to which the splatter image representation preserves appearance details of the single input image.

6. The method of claim 1, further comprising:
generating a plurality of three-dimensional scene representations from the single input image by repeating the concatenating, iteratively denoising, decoding, and backprojecting steps using a different random latent code for each repetition,
wherein each of the plurality of three-dimensional scene representations provides a different completion of the unobserved surfaces while maintaining consistency with observed surfaces of the scene.

7. The method of claim 1, further comprising:
adjusting, at inference time, a classifier-free guidance weight to control a balance between fidelity of the three-dimensional scene representation to the single input image and diversity of completions for the unobserved surfaces.

8. The method of claim 1, wherein each Gaussian splat in the pixel-aligned grid is defined by a set of parameters comprising a three-dimensional position, an opacity value, color coefficients, and scale and rotation parameters of a covariance matrix, and wherein the decoder outputs M sets of the parameters per pixel of the splatter image representation, M being an integer greater than or equal to one.

9. A non-transitory computer-readable medium storing instructions that, when executed by one or more processors, cause a computing system to perform operations for generating a three-dimensional scene representation from a single input image, the operations comprising:
receiving a single input image of a scene;
encoding the single input image using a first encoder to generate conditioning features;
concatenating the conditioning features with a random latent code to produce a combined latent representation;
iteratively denoising the combined latent representation using a denoising diffusion model conditioned on the conditioning features to produce a denoised latent code;
decoding the denoised latent code using a decoder to generate a splatter image representation, wherein the splatter image representation comprises a pixel-aligned grid of Gaussian splat parameters representing both observed and unobserved surfaces of the scene; and
backprojecting the splatter image representation into three-dimensional space to produce a set of three-dimensional Gaussian splats for rendering the scene from arbitrary viewpoints.

10. The non-transitory computer-readable medium of claim 9, wherein the decoder receives, in addition to the denoised latent code, skip connection features derived from a second encoder that encodes the single input image, the skip connection features providing high-frequency detail from the single input image to the decoder to improve fidelity of the splatter image representation to visible surfaces of the scene.

11. The non-transitory computer-readable medium of claim 10, wherein the denoising diffusion model is trained by a process comprising:
training an encoder-decoder network using self-supervised losses computed by rendering predicted Gaussian splats from a plurality of target camera poses and comparing rendered images to corresponding ground truth images captured from those poses, thereby learning a latent space of splatter image representations; and
training the denoising diffusion model on latent codes produced by the trained encoder-decoder network, wherein training the denoising diffusion model comprises adding noise to the latent codes and training a denoising network to predict and remove the added noise.

12. The non-transitory computer-readable medium of claim 11, wherein training the encoder-decoder network comprises:
randomly zeroing out the skip connection features during training to prevent the encoder-decoder network from encoding scene information exclusively in the skip connection features and to ensure that the latent codes capture scene information sufficient for the denoising diffusion model.

13. The non-transitory computer-readable medium of claim 10, wherein the operations further comprise:
adjusting, at inference time, a weight applied to the skip connection features to control a degree to which the splatter image representation preserves appearance details of the single input image.

14. The non-transitory computer-readable medium of claim 9, wherein the operations further comprise:
generating a plurality of three-dimensional scene representations from the single input image by repeating the concatenating, iteratively denoising, decoding, and backprojecting steps using a different random latent code for each repetition,
wherein each of the plurality of three-dimensional scene representations provides a different completion of the unobserved surfaces while maintaining consistency with observed surfaces of the scene.

15. The non-transitory computer-readable medium of claim 9, wherein the operations further comprise:
adjusting, at inference time, a classifier-free guidance weight to control a balance between fidelity of the three-dimensional scene representation to the single input image and diversity of completions for the unobserved surfaces.

16. The non-transitory computer-readable medium of claim 9, wherein each Gaussian splat in the pixel-aligned grid is defined by a set of parameters comprising a three-dimensional position, an opacity value, color coefficients, and scale and rotation parameters of a covariance matrix, and wherein the decoder outputs M sets of the parameters per pixel of the splatter image representation, M being an integer greater than or equal to one.

17. A system for generating a three-dimensional scene representation from a single input image, the system comprising:
one or more processors; and
a memory storing instructions that, when executed by the one or more processors, cause the system to:
receive a single input image of a scene;
encode the single input image using a first encoder to generate conditioning features;
concatenate the conditioning features with a random latent code to produce a combined latent representation;
iteratively denoise the combined latent representation using a denoising diffusion model conditioned on the conditioning features to produce a denoised latent code;
decode the denoised latent code using a decoder to generate a splatter image representation, wherein the splatter image representation comprises a pixel-aligned grid of Gaussian splat parameters representing both observed and unobserved surfaces of the scene; and
backproject the splatter image representation into three-dimensional space to produce a set of three-dimensional Gaussian splats for rendering the scene from arbitrary viewpoints.

18. The system of claim 17, wherein the decoder receives, in addition to the denoised latent code, skip connection features derived from a second encoder that encodes the single input image, the skip connection features providing high-frequency detail from the single input image to the decoder to improve fidelity of the splatter image representation to visible surfaces of the scene.

19. The system of claim 18, wherein the denoising diffusion model is trained by a process comprising:
training an encoder-decoder network using self-supervised losses computed by rendering predicted Gaussian splats from a plurality of target camera poses and comparing rendered images to corresponding ground truth images captured from those poses, thereby learning a latent space of splatter image representations; and
training the denoising diffusion model on latent codes produced by the trained encoder-decoder network, wherein training the denoising diffusion model comprises adding noise to the latent codes and training a denoising network to predict and remove the added noise.

20. The system of claim 17, wherein the instructions further cause the system to:
generate a plurality of three-dimensional scene representations from the single input image by repeating the concatenate, iteratively denoise, decode, and backproject steps using a different random latent code for each repetition,
wherein each of the plurality of three-dimensional scene representations provides a different completion of the unobserved surfaces while maintaining consistency with observed surfaces of the scene.
